(19) United States
(12) Patent Application Publication
(10) Pub. No.: US 2002/0106466 A1
(43) Pub. Date: Aug. 8, 2002

(54) Active amine scavenging film for fresh fish packaging

(76) Inventors: Karlheinz Hausmann, Auvernier (CH); Francesca Mostardini, Milano (IT)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/923,621

(22) Filed: Aug. 7, 2001

Related U.S. Application Data
(60) Provisional application No. 60/226,189, filed on Aug. 18, 2000.

(51) Int. Cl. B32B 1/02

(52) U.S. Cl. 428/35.2

(57) ABSTRACT

A flexible film packaging structure capable of adsorbing undesireous amine components from the headspace of the package. The structure has at least one layer that includes at least one copolymer of ethylene with an α,β-ethylenically unsaturated carboxylic acid having from 3 to 8 carbon atoms, the copolymer having optionally up to 99% of the carboxylic acid groups neutralized by metal ions.

### BACKGROUND OF INVENTION

This application claims the benefit of U.S. Provisional Application No. 60/226,189, filed Aug. 18, 2000, which is incorporated by reference as if fully set forth herein for all purposes.

### FIELD OF INVENTION

This invention relates to packages capable of removing volatile odiferous compounds such as amines from the headspace of a package, thus improving the odor of the package. These packages are particularly useful for packaging fish or other perishable food items generating amines.

### BACKGROUND DISCUSSION AND RELATED ART

One of the challenges food packaging industry has to cope with is to preserve packaged goods as long as possible, in order to increase the shelf life of the package. A particular problem is encountered in modified atmosphere packagings (MAP): these packagings present a headspace between the packaged good and the packaging film covering the packaged goods, where some unwanted compounds may accumulate during the shelf life. It is known to add additives and substances to packaging films in order to either release substances to the packaged good or to remove substances, either present in the headspace of the packages or generated by the packaged good, from the headspace.

These so-called active packaging products are for instance capable of removing oxygen, sulfites or aldehydes, from the packaging headspace. U.S. Pat. No. 5,654,061 to Visioli, incorporated herein by reference for all purposes, discloses the incorporation of zeolites into the packaging seal layer in order to adsorb volatile odorous sulfur compounds from the packaging headspace and therefore improve the consumer acceptance of packaged poultry.

Until nowadays, fresh fish has been mainly transported on ice and then distributed and sold as quickly as possible. Only recently has the packaging of fish in modified atmosphere started. Nevertheless, due to the problem of generation of amines during storage of fish, the packaging of fresh fish is still not common. Although amines generated by bacteria during the aging of fish can be considered as a freshness indicator, they usually smell bad and their accumulation in the headspace of fresh fish can lead to rejection by the consumer despite the fact that the fish can still be considered as fresh. In consequence, although the shelf life of fresh fish packaged in MAP can be more than doubled, and more cost effective distribution channels can be used, fresh fish packaging has not yet had the success one could have expected. Removing some of these amines would significantly reduce the number of rejects and extend the shelf life without compromising consumer safety and health.

Most of the solutions to this problem provided in the art have in common that they require either the addition of a polymer or substance to the package or the incorporation of an additional component into one of the layers of the multilayer film of the flexible film that makes up the package. JP 59-162832 A2 claims the addition of a polymeric substance, e.g. polyacrylate, to a vegetable package to remove bad odor such as amines from the package. One drawback of the above solutions is that the adsorber has to be incorporated in the package, via for instance the use of an additional sachet, or in the packaging film. In both cases, this may cause concerns with regard to consumer acceptance and safety (accidental consumption of the additional odor adsorbing sachet in the food package) or to food approval by governmental authorities due to the incorporation of an odor-adsorbing substance.

Therefore, there is still a need for a package useful for packaging fish or other perishable food items that would remove volatile odiferous compounds, and particularly amines, from inside of the package and that would not require the addition of an odor-adsorbing substance.

### SUMMARY OF INVENTION

The present invention pertains to the discovery that a polymer film comprising a copolymer of ethylene with an α,β-ethylenically unsaturated carboxylic acid having 3 to 8 carbon atoms, optionally having up to 99% of the carboxylic acid groups neutralized by metal ions, can be used to absorb odiferous compounds, particularly amines. The use of such polymer film is particularly useful in packages for packaging fish or other perishable food items to control odiferous compounds, particularly amines, generated by the fish or perishable food.

In one aspect, the present invention is a package useful for packaging fish or other perishable food items, the package comprising a multilayer polymer film having at least one adsorbent layer comprising at least one polymer that removes volatile odiferous compounds from inside of the package, wherein the polymer comprises a copolymer of ethylene with an α,β-ethylenically unsaturated carboxylic acid having from 3 to 8 carbon atoms, said copolymer optionally having up to 99% of the carboxylic acid groups neutralized by metal ions.

In another aspect, the present invention is a package useful for packaging fish or other perishable food items, the package comprising a multilayer polymer film having a sealant layer, the sealant layer being the topmost layer of the film such that the sealant layer is in direct contact with the packaged item, wherein the sealant layer comprises at least one polymer that removes volatile odiferous compounds from inside of the package, wherein the polymer comprises a copolymer of ethylene with an α,β-ethylenically unsaturated carboxylic acid having from 3 to 8 carbon atoms, said copolymer optionally having up to 99% of the carboxylic acid groups neutralized by metal ions.

In still another aspect, the present invention is a package useful for packaging fish or other perishable food items, the package comprising a multilayer polymer film having at least one layer comprising at least one polymer that removes volatile odiferous compounds from inside of the package, wherein the film additionally comprises active ingredients, which have as one of their properties the adsorption of amines. It has been found that surprisingly, when such active amine absorbing ingredients are incorporated, the capability of the adsorbent polymer to adsorb the amine itself is reduced, particularly to a level at or below that level of amines that is generated by fish that is unfit for consumption. In this way, it is possible to remove objectionable amine odor (low levels) while at the same time retaining an indicator of dangerous deterioration of packaged food such as fish. That is, when the package design is adjusted as provided in this invention to only absorb up to a safe amount of amine and no more, the higher amine levels normally associated with dangerous deterioration of packaged foods such as fresh fish will not be absorbed. As such, if there is dangerous deterioration, the amine odor will be evident when the package is opened providing an accurate warning. On the other hand, if there is no dangerous deterioration, the amine odor will not be present.

In another aspect, the invention is a method for removing amines from the headspace of a modified atmosphere package (MAP) useful for packaging fish or other perishable food items, comprising incorporating inside the multilayer film making up the package a layer comprising at least a polymer comprising a copolymer of ethylene with an α,β-ethylenically unsaturated carboxylic acid having from 3 to 8 carbon atoms, said copolymer optionally having up to 99% of the carboxylic acid groups neutralized by metal ions.

### DETAILED DESCRIPTION OF INVENTION

The present invention provides a method of removing or controlling undesirable, generally bad smelling, components, such as amines, that emanate from fresh fish and other perishable foods when contained in a package. The method comprises removing from or controlling the level of amines in the headspace of a package, particularly a modified atmosphere package, useful for packaging fish or other perishable food items, by incorporating into a multilayer film that forms at least part of the package structure at least one layer comprising at least one polymer comprising a copolymer of ethylene with an α,β-ethylenically unsaturated carboxylic acid having from 3 to 8 carbon atoms, optionally having up to 99% of the carboxylic acid groups neutralized by metal ions. The method further comprises introduction of an active ingredient having as one of its properties the ability to adsorb amines (such as zeolites) into the package, particularly into the ethylene copolymer containing layer. By introducing a sufficient amount of the active ingredient, the capacity of the adsorbent polymer to adsorb the amine is reduced and the extent of amine absorption can be controlled so as to not reduce the amines to a level at or below that level of amines generated by fish that is unfit for consumption.

The package of the invention comprises a multilayer film which comprises at least one layer containing a specific ethylene copolymer with the capability of adsorbing the undesireous, in most of the cases bad smelling, components. More specifically this specific ethylene copolymer is a copolymer of ethylene with an α,β-ethylenically unsaturated carboxylic acid having from 3 to 8 carbon atoms, said copolymer optionally having up to 90% of the carboxylic acid groups optionally neutralized by metal ions. Preferably the ethylene copolymer contains 1 to 50 weight percent (wt. %) of the acid co-monomer based on the weight of the ethylene copolymer, and more preferably from 2 to 19 wt. %. Preferred α,β-ethylenically unsaturated acids contain 3 to 8 carbon atoms and particularly include acrylic acid, methacrylic acid and itaconic acid. The melt index of the ethylene copolymer, measured according to ASTM D 1238 @ 190° C./2.16 kg, is preferably less than 30 g/10 min, and more preferably less than 20 g/10 min. The ethylene copolymer can be random or non-random, but random is preferred.

The ethylene copolymer may optionally comprise one or more softening comonomers copolymerizable with ethylene. The softening monomer is preferably present in an amount of less than about 25 wt. %, relative to the weight of the ethylene copolymer. The softening comonomer can be an alkyl acrylate selected from the group consisting of methyl acrylate, n-propyl-, iso-butyl-, n-butyl-, n-octyl-, 2-ethylhexyl-. and 2-methoxyethyl-acrylates. The preferred alkyl acrylates are iso-butyl-, n-butyl-, 2-ethylhexyl-, and 2-methoxyethyl-acrylates. The softening comonomer can also be an alkyl vinyl ether selected from the group consisting of n-butyl-, n-hexyl-, 2-ethylhexyl-, and 2-methoxyethyl-vinyl ether. The preferred alkyl vinyl ethers are n-butyl vinyl ether and n-hexyl vinyl ether.

The ethylene copolymer is optionally about 0.01 to 99.5% neutralized with metal ions selected from groups Ia, Ib, IIa, IIIa, IVa, VIb, and VII of the Periodic Table of Elements such as sodium, potassium, zinc, calcium, magnesium, lithium, aluminum, nickel, and chromium. Such neutralized ethylene acid copolymers are known in the art as ‘ionomers’. The preferred neutralization is about 10 to 99% more preferably 15 to 50% of the acid groups present in the copolymer. The preferred metal ions for neutralizing the acid groups are Na⁺, K⁺, Li⁺, Mg²⁺, Ca²⁺ and Zn²⁺.

Although to be effective as an amine adsorbing substance it is preferred that the ethylene copolymer is not neutralized at all with metal ions, other properties relating to the performance of the package and its life, such as seal strength, sealing through contamination, package shelf life, seal integrity, are improved through the use of a neutralized ethylene copolymer. Thus, the preferred ethylene copolymer is a copolymer or ionomer of ethylene containing 2-19 wt % methacrylic or acrylic acid. The preferred ionomer preferably has 15-50% of the acid groups neutralized with metal ions.

Suitable ethylene copolymers for use in the present invention are the ionomers commercially available under the trademark Surlyn® from E. I. du Pont de Nemours and Company, Delaware, and the ethylene acid copolymers available under the trademark Nucrel® from E.I. du Pont de Nemours and Company, Delaware.

Description of the preparation of these ionomers and ethylene acid copolymers and the melt fabrication of film therefrom are provided in U.S. Pat. No. 4,248,990; U.S. Pat. No. 3,264,272; and U.S. Pat. No. 4,351,931, all incorporated herein by reference for all purposes.

The multilayer film of the invention preferably comprises at least three layers which are the structural layer, the barrier layer and the sealant layer. The structural layer is usually the body of the packaging film, it is usually situated between the barrier layer and the sealant layer. The barrier layer is typically the external layer. The sealant layer is usually in direct contact with the food and headspace. These layers may be laminated or coextruded.

The layer comprising the ethylene copolymer can be incorporated anywhere in the structure, either in replacement of or in addition to one of the three above layers. This layer can be an adsorbent layer. By “adsorbent layer,” it is meant herein a layer removing volatile odiferous compounds, in particular amines, from inside the package. Preferably the layer comprising the ethylene copolymer is as close to the packaged good as possible and more preferably it is the sealant layer.

The ethylene copolymer of the invention can be contained in pure or blended form with other polymers such as with other alpha polyolefins. These other alpha polyolefins may be copolymers of ethylene and octene, copolymers of ethylene and butene, copolymers of ethylene and hexene and mixtures thereof. When it is used in a layer other than the sealant layer, the permeability of the layers between the packaged good and the said ethylene copolymer layer should be high enough to allow for the amines to permeate these layers within a reasonable time (a short enough time that the amines preferably permeate at a rate at least as high as they are generated in the headspace). In the sealant layer, the ethylene copolymer can be used as pure polymer or it can be blended with other polymers, preferably with other polyolefins.

The layers of the film may further comprise additives or active ingredients such as amine adsorbents. Amine adsorbents may include zeolites. When such active absorbents are added, the capability for the polymer film of the present invention to adsorb amines from the head space can be reduced. As can be seen in the examples, the capacity to absorb amines seems to be higher and quicker when such other additives are not present in the ethylene copolymer. The agent preferably is included in an amount selected to control the absorption of odiferous compounds sufficiently to eliminate levels that are noisome but not indicative of dangerous deterioration of the food.

In one embodiment of the invention, the layer comprising the ethylene copolymer consists essentially of the ethylene copolymer. In another embodiment of the invention, it consists of the ethylene copolymer only. In another embodiment of the invention, the layer comprising the ethylene copolymer consists only of the ethylene copolymer and it is the sealant layer.

The layers of the film which do not comprise the ethylene copolymer may comprise any suitable polymer usually used in the manufacture of packaging films, such as polyamide, polyester, polystyrene, polyethylene, polypropylene, ethylene vinyl alcohol, metal and mixtures thereof. These layers may be oriented or not.

The package of the invention preferably comprises a modified atmosphere headspace. By “headspace” is meant herein the space existing between the good or the food item and the multilayer film that makes up the package. The modified atmosphere of the headspace preferably comprises carbon dioxide and nitrogen.

The multilayer film of the invention has a significantly higher capability of removing amines from the headspace of fresh fish packages than any other packaging concept available. Moreover, this multilayer film does not necessarily require the introduction of any new substances into the package, and the ethylene copolymer of the invention is already approved for use in direct food contact.

### EXAMPLES

Several multilayer films of the structure PE/Tie/EVOH/Tie/Sealant Layer, where PE (polyethylene) is the barrier layer and EVOH (ethylene vinyl alcohol) is the structural layer were prepared. The materials used and the ethylene copolymers used in the Sealant Layer are collected in the following Tables I, II and III:

TABLE I

| | |
|---|---|
| PE: | HDPE 6985 (density 0.958, MFI 1.2) from Borealis AS, |
| | Denmark |
| Tie: | Bynel ® XB719 (VLDPE, density 0.92, grafted with 0.25% |
| | maleic anhydride, MFI 5.2) and Bynel ® 40E529 (HDPE, |
| | density 0.96, grafted with 0.18% maleic anhydride, MFI 3.5), |
| | both available from DuPont de Nemours Int. SA Geneva |
| EVOH: | F101 (copolymer of 32% ethylene with vinyl alcohol) from |
| | Kuraray, Japan |

TABLE II
Ethylene Copolymer used in the Sealant Layer

| | |
|---|---|
| Ionomer 1 | Copolymer of ethylene and 9 wt % methacrylic acid, |
| | 18% neutralized with Zn ions; MFI = 14 at 190° C./ |
| | 2.16 kg (ASTM 1238) |
| Acid Copolymer | Nucrel ® 3990-E: copolymer of ethylene and |
| | 10 wt % acrylic acid, MFI (190° C./2.16 kg) of 10 g/ |
| | 10 min (ASTM 1238) commercially available from |
| | E.I. du Pont de Nemours and Company, Delaware. |

TABLE III

| | |
|---|---|
| Active Ingredient: | Abscents ® 3000: Zeolite, manufactured by UOP, |
| | Japan, as amine scavenger |
| Control | Multilayer Barrier film sold as BBL4 from |
| | CRYOVAC with EVA (ethyl vinyl acetate) sealant |
| | layer. These bags were also used as barrier bags for |
| | storage of the other films after it was shown that they |
| | do not adsorb anything by themselves |
| Amine | Trimethylamine (TMA), 31-35% in ethanol, |
| | from FLUKA |

The films in the following examples were prepared on a 45 mm Reifenhaeuser blown film extrusion line with a Barmag 5 layer blown film line. The temperature profile is as follows (in ° C.):

| | Zone 1 | Zone 2 | Zone 3 | Zone 4 | Die | Melt |
|---|---|---|---|---|---|---|
| Low T | 140 | 150 | 160 | 180 | 210 | 210 |

### Control Example 1 (Film 1)

Multilayer Barrier film sold as BBL4 from CRYOVAC—five-layer structure believed to be 20 μm ethylene vinyl acetate (EVA)/5 μm polyvinylidene chloride/10 μm EVA/16 μm EVA/10 μm LLDPE.

### Example 1 (Film 2)

HDPE (40 μm)/Bynel®40E529/EVOH (5 μm)/Bynel® XB719/Ionomer 1 (25 μm).

### Example 1A (Film 3)

HDPE (40 μm)/Bynel® 40E529/EVOH (5 μm)/Bynel® XB719/Ionomer 1 (25 μm)+4 wt. % Abscents® 3000 in Ionomer 1.

### Example2 (Film 4)

Aluminum foil/Acid Copolymer (25 μm).

Measurement of Amine Absorption

The film structures in each of the examples were analyzed as follows.

TABLE IV
Analytical conditions and equipment used for HS-GC analysis

| | |
|---|---|
| HS: STATIC HEADSPACE | GC: GAS CHROMATOGRAPH |
| ANALYSER Hs-40 Perkin Elmer | HP 5890 series II |
| Sample thermostatation: off | Column: Carbowax 20M; |
| | 25 m * 0.53 mm; 1 μm film thickness |
| Pressurization time: 3 min | Temperature programme: |
| | 50° C. (10 min); 20° C./min to |
| | 200° C. |
| Injection time: 0.1 min | Injection: splitless |
| Needle temperature: 155° C. | Injector temperature: 150° C. |
| Transfer line temperature: | Detector: FID at 280° C. |
| 160° C. | Carrier gas (flow): Helium (2.2 |
| | mL/min) |

Ten (10) cm² of each film were put into 22 mL glass vials together with 1 μL of TMA solution in ethanol. The vials (two for each solution of film) were conditioned at 4-5° C. for 1 and 3 days. Then, at fixed interval of time (2 hours), an headspace analysis was performed (see Table IV for analitical set up and GC conditions) in order to determine only the residual amine in the headspace.

The adsorption amount (μg 10 cm⁻²) was calculated by determining the concentration decrease of the TMA inside the headspace glass vial. That is, by substracting the residual amounts from the initial content after 24 hours and after 72 hours, absorbed amounts were calculated and reported in Table V.

TABLE V

| | Control 1 | Example 1 | Example 1A | Example 2 |
|---|---|---|---|---|
| | 1 | 2 | 3 | 4 |
| | μg TMA | μg TMA | μg TMA | μg TMA |
| Film: | adsorbed | adsorbed | adsorbed | adsorbed |
| Time | per 10 cm² | per 10 cm² | per 10 cm² | per 10 cm² |
| 24 hr. | 0 | 28 | 29 | 37 |
| 72 hr. | 0 | 120 | 60 | 140 |

As can be seen from Table V, the film structure of Control 1 contains only polymers that do not interact with amines in the structure. Therefore no amine adsorption is noted after 24 or 76 hours.

On the other hand, the film structure of Example 1 in which Ionomer 1 is contained as a sealant layer, clearly is effective in absorbing the amine. From Example 1A (active amine adsorber, Abscents® 3000, is added to the Ionomer in the structure), it can be seen that amine absorption by the film after 24 hours is comparable to that of the structure of Example 1 (same structure as in Example 1A other than for the addition of the amine absorber). At 76 hours, however, it can be seen that absorption of amines is hindered when the active amine absorber is added.

It can also be seen that the film structure of Example 2 in which a non-neutralized ethylene acid copolymer is employed as a sealant layer, amine absoption appears to be somewhat greater than in the case of ionomer (Example 1).

1. A package useful for packaging fish or other perishable food items, the package comprising a multilayer polymer film having at least one adsorbent layer comprising at least one polymer that removes volatile odiferous compounds from inside of the package, wherein the polymer comprises a copolymer of ethylene with an α,β-ethylenically unsaturated carboxylic acid having from 3 to 8 carbon atoms.

2. The package of claim 1, wherein the copolymer of ethylene and α,β-ethylenically unsaturated carboxylic acid has up to 99% of the carboxylic acid groups neutralized by metal ions.

3. The package of claim 1 or claim 2, wherein the multilayer polymer film has a sealant layer, the sealant layer being the topmost layer of the film such that the sealant layer is in direct contact with the packaged item, wherein the absorbent layer is the sealant layer.

4. The package of claim 1 or claim 2 wherein the film additionally comprises active ingredients which have as one of their properties the adsorption of amines, whereby the capacity of the adsorbent polymer to adsorb the amine is reduced, and whereby the capacity of the adsorbent polymers to adsorb amines is reduced to a level at or below that level of amines generated by fish that is unfit for consumption.

5. The package of claim 3 wherein the film additionally comprises active ingredients which have as one of their properties the adsorption of amines, whereby the capacity of the adsorbent polymer to adsorb the amine is reduced, and whereby the capacity of the adsorbent polymers to adsorb amines is reduced to a level at or below that level of amines generated by fish that is unfit for consumption.

6. The package of claim 1 wherein the copolymer comprises from about 1 to about 50% of acid comonomer, by weight, based on the weight of the copolymer.

7. The package of claim 5, wherein the copolymer comprises from about 2 to about 19% of acid comonomer, by weight, based on the weight of the copolymer.

8. The package of claim 1, wherein the package has a modified atmosphere headspace.

9. A method for removing amines from the headspace of a modified atmosphere package useful for packaging fish or other perishable food items, said package having a multilayer film as part of its structure, comprising incorporating in the multilayer film at least one layer comprising at least one polymer comprising a copolymer of ethylene with an α,β-ethylenically unsaturated carboxylic acid having from 3 to 8 carbon atoms.

10. The method of claim 9, wherein the layer incorporated in the multilayer film comprises at least one polymer comprising a copolymer of ethylene with an α,β-ethylenically unsaturated carboxylic acid having from 3 to 8 carbon atoms, said copolymer having up to 99% of the carboxylic acid groups neutralized by metal ions.

11. The method of claim 10 further comprising the addition of an active ingredient having as one of its properties the ability to adsorb amines.

12. The method of claim 11 wherein active ingredient is added in an amount sufficient to reduce the capacity of the adsorbent polymer to a level that the polymer, while absorbing enough amine to increase shelf life of packaged fish or other perishable food, does not absorb amine when present at a level that would indicate that the packaged fish or other perishable food is unfit for consumption.
